(19) United States
(12) Patent Application Publication
(10) Pub. No.: US 2004/0204151 A1
(43) Pub. Date: Oct. 14, 2004

(54) Method and apparatus for advising a user of a wireless device as to a connection status thereof

(76) Inventors: Sivakumar Muthuswamy, Plantation, FL (US); Steven Duane Pratt, Ft. Lauderdale, FL (US); Ronald James Kelley, Coral Springs, FL (US)

Correspondence Address: Daniel C. Crilly, Motorola, Inc., Law Department, 8000 West Sunrise Boulevard, Fort Lauderdale, FL, 33322, US

(21) Appl. No.: 10/331,753

(22) Filed: Dec. 30, 2002

(51) Int. Cl. H04B 1/38

(52) U.S. Cl. 455/567; 455/566; 455/90.1

(57) ABSTRACT

Wireless communication devices (102, 104, 106, 108, 110) include multi-state visual indicating devices (114, 116, 118, 120, 122, 126, 128) that are operable to alert users that wireless communication links or connections have been established between two or more devices. Upon establishing a connection, the wireless devices share indicia activation information (e.g., color or timing sequence information) and the multi-state visual indicating devices in the devices operate according to the indicia activation information to apprise users that the connection has been established. Activatable indicia (216, 214, 216, 218) that are preferably integral with the wireless device housings inform the device users as to the state of communication.

### FIELD OF THE INVENTION

The present invention relates in general to wireless communications. More particularly, the present invention relates to advising a user of a wireless device as to a connection status of a wireless communication.

### BACKGROUND OF THE INVENTION

Advances in electronic manufacture techniques (e.g., semiconductor lithography) have greatly reduced the cost of including computing and communication functionality in electronic apparatus. It is contemplated that computing and communication functionality will be included in a wide variety of electronic apparatuses (e.g., consumer electronics) that have not had such functionality.

Personal area networks (PAN) that span a set of devices (e.g., wireless telephone, notebook computer, and personal digital assistant PDA) carried by a single person are contemplated. PANs can for example be used to transfer email messages received via a data communication enabled wireless telephone to a PDA or laptop for reading. Wirelessly connected stationary home electronics are also contemplated. Wirelessly connecting multiple devices will enable them to interact and to more efficiently serve their user's needs. So as not to burden the user, wireless connections are, in certain instances, to be set up automatically as devices move within range of each other. For example, when a portable device carried by the user, is moved within range of other devices (e.g., stationary devices) in their home or business such devices are expected to automatically establish communications for the purpose of exchanging useful information or control signals without the intercession of the user. Such automatic communications open up a wide variety of possible methods for automating various home and business functions and increasing the user's productivity and quality of life. However, given that inter-device communication is to be established without the user's intercession, coupled with the present lack of familiarity with such systems, it is anticipated that such system may lead to consumer uncertainty and apprehension. Uncertainty as to whether devices are communicating and the status of such communication in each particular instance, may lead to false expectations as to whether or not devices are communicating, and in general to uncertainty as to the capability of such systems. In the case that more than two devices that are capable of communicating on an ad hoc basis are in range of each other uncertainty may arise as to which if any devices are communicating.

### BRIEF DESCRIPTION OF THE FIGURES

The present invention will be described by way of exemplary embodiments, but not limitations, illustrated in the accompanying drawings in which like references denote similar elements, and in which:

FIG. 1 is a system diagram of a wireless network according to the preferred embodiment of the invention;

FIG. 2 is a front view of a wireless telephone included in the network shown in FIG. 1 according to the preferred embodiment of the present invention;

FIG. 3 is a sectional side view of the wireless telephone shown in FIG. 2;

FIG. 4 is a functional block diagram of the wireless telephone shown in FIGS. 2-3;

FIG. 5 is a flow chart of method of operating the wireless telephone shown in FIGS. 1-4 in conjunction with a second wireless communication enabled device according to the preferred embodiment of the invention;

FIG. 6 is a flow chart of a method of operating a second wireless communication enabled device in coordination with the method shown in FIG. 5

FIG. 7 is flow chart of a method of operating the wireless telephone shown in FIGS. 1-4 according to an alternative embodiment of the invention;

FIG. 8 is a flow chart of a method of operating a second wireless enabled communication device in coordination with the method shown in FIG. 7.

FIG. 9 is a fragmentary perspective view of a front housing portion of the wireless telephone shown in FIGS. 1-4 including an electroluminescent activatable indicia;

FIG. 10 is a fragmentary perspective view of the front housing portion, and a circuit substrate of the wireless telephone shown in FIGS. 1-4 including a photoluminescent activatable indicia;

FIG. 11 is a fragmentary perspective view of the front housing portion, and the circuit substrate of the wireless telephone shown in FIGS. 2-4 including an etched pass through type activatable indicia;

FIG. 12 is a fragmentary perspective x-ray view of the front housing portion of the wireless telephone shown in FIGS. 2-4 including a thermochromic activatable indicia; and

FIG. 13 is a fragmentary perspective view of the front housing portion, and the circuit substrate of the wireless telephone shown in FIGS. 2-4 including a leaky fiber indicator lamp.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including”, “comprising” and/or “having”, as used herein, are defined as a non-exclusive inclusion (i.e., open language). The term “coupled”, as used herein, is defined as connected, although not necessarily directly and not necessarily mechanically.

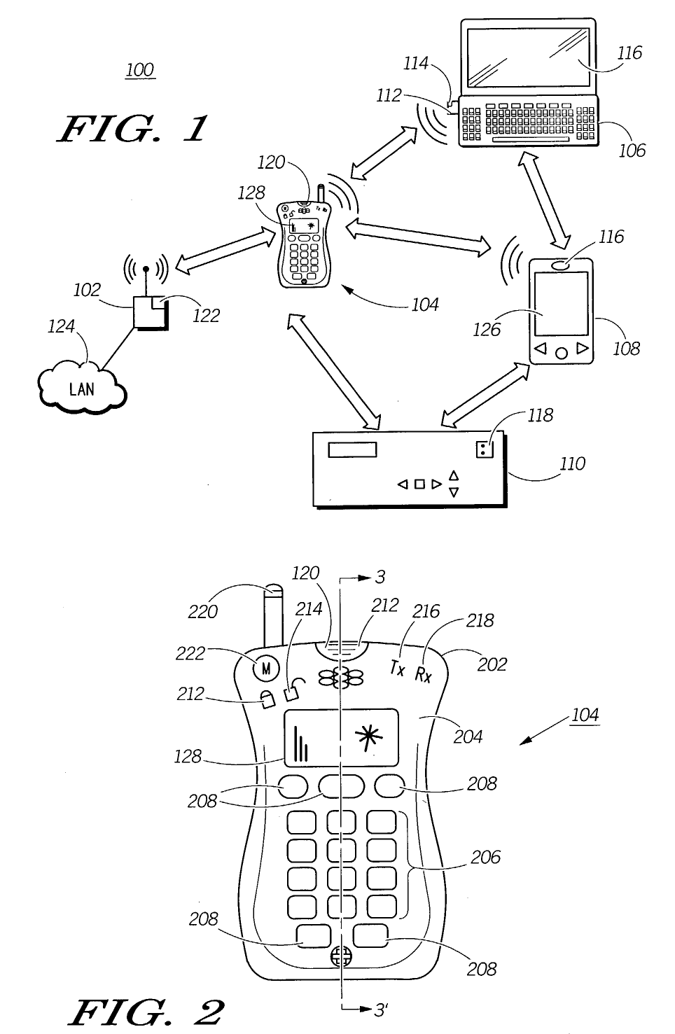

FIG. 1 is a system diagram of a wireless network 100 according to the preferred embodiment of the invention. A plurality of disparate type wireless communication enabled devices 102, 104, 106, 108, 110 including a network portal 102, a wireless telephone 104, a laptop computer 106, a PDA 108, and a set top box 110 are parties to the wireless network 100. The network portal 102 is communicatively coupled to a local area network (LAN) 124. Each of the devices 102-110 participating in the wireless network 100 includes a multi-state visual indicating device such as a display or an indicator lamp. Multiple states of the visual indicators are characterized by different intensity levels (e.g., on and off), different colors, different spatial patterns (e.g., icons, or images) or a combination thereof. The laptop 106 includes a wireless network card 112 that includes an indicator lamp 114. The laptop also includes a display 116. The PDA 108 includes an indicator lamp 116. The set top box 110 includes an indicator lamp 118. The wireless telephone 104 includes an indicator lamp 120, and the network portal 102 includes an indicator lamp 122. The PDA 108 also includes a display screen 126, and the telephone 104 includes a display screen 128. As described more fully below sets (e.g., pairs) of indicator lamps, or display screens of the devices 102-110 are operated together to alert users that one or more wireless communication links have been established between two or more of the devices 102-110.

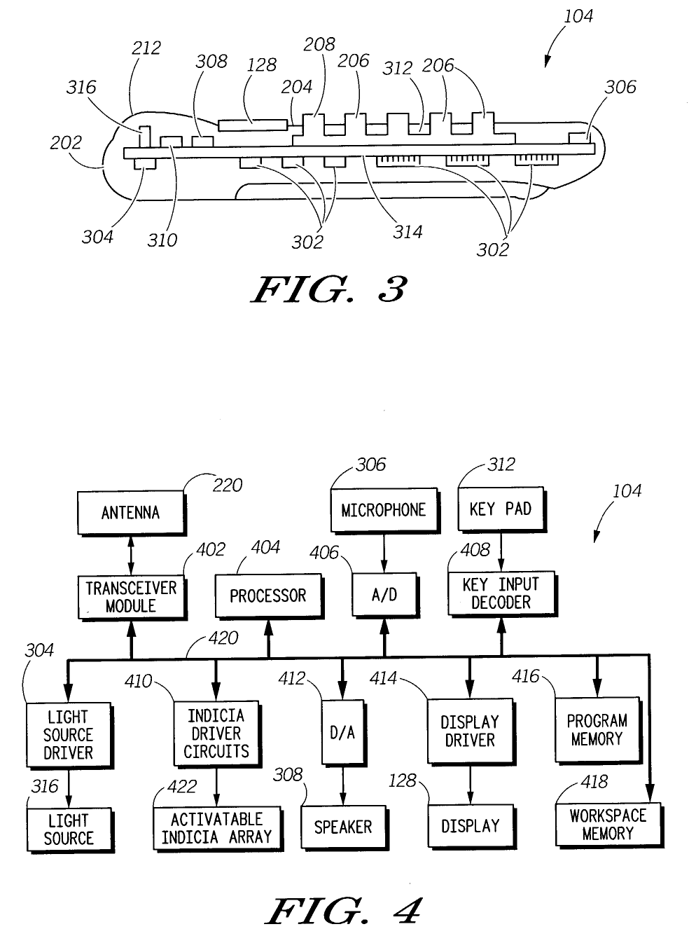

FIG. 2 is a front view of the wireless telephone 104 included in the network shown in FIG. 1 according to a preferred embodiment of the present invention and FIG. 3 is a sectional side view of the wireless telephone 104 shown in FIG. 2. Although the invention is described in detail herein below with reference to the wireless telephone 104, the invention is alternatively applied to other electronic devices such as, for example, two-way messaging devices, personal digital assistants, fixed wireless network access nodes, home entertainment equipment such as set top boxes, and associated remote controls, smart home control nodes, game controllers and associated game boxes, personal computers and associated peripherals such as printers, scanners, and plotters, point of sale terminals and associated hand held scanners, including the devices shown in FIG. 1.

Referring to FIG. 2, the wireless telephone 104 comprises a housing 202 that includes a front housing portion 204. The front housing portion 204 supports a plurality of momentary contact keys 206, 208, including a set of alphanumeric keys 206 that are used to input alphanumeric data including telephone numbers, and other telephone book data (e.g., names). Also included among the momentary contact keys 206, 208, are a number of function keys 208. The wireless telephone 202 includes a display 128 that is useful, among other things, for displaying phone number and operating status information (e.g., signal strength, battery reserve). The telephone 104 includes an antenna 220. The front housing portion 204, is alternatively a removable interchangeable face plate.

The front housing portion 204 includes a window 212, over a light source 316. The light source 316, in combination with the window 212 serves as the lamp 120 identified with reference to FIG. 1. The light source 316, and a light source on another device (e.g., another wireless telephone, network node, PDA, lap top computer) with which the wireless telephone 104 establishes a communication link are preferably turned on to indicate that the communication link has been established. In order to reduce ambiguity in indicating that two devices have established a communication link, the light sources in the two devices that have established a communication link are preferably activated according to the same activation information. The common activation information preferably takes the form of a timing sequence according to which light sources in two devices which have established a communication link are activated. Such a timing sequence may for example comprise a predetermined set of on periods (e.g., two seconds, two seconds, two seconds), interleaved with a predetermined set of off periods (e.g. one second, one second, one second). Preferably driving of the light sources according to the timing sequence is synchronized. Rather than using two discrete states (e.g., on and off) the intensity of light sources in the two devices are alternatively modulated continuously. In the preferred embodiment, a synchronization signal is transmitted between the two devices in order to synchronize driving of the light sources in the two devices according to the timing sequence.

The light source 316 is preferably an LED. Alternatively, the light source is an electroluminescent lamp, or a photoluminescent lamp that is excited by a UV LED. In the latter two cases the electroluminescent, or photoluminescent material is preferably located on an external surface of the front housing portion 204. In the latter case the window 120 can be dispensed with.

According to another alternative embodiment, the light source 316 is a full color light emitting diode (LED). Full color LEDs include three separately drivable LED chips e.g. a red, a green and a blue chip. In such an alternative embodiment, the activation information preferably takes the form of a color selection signal, which is to say that the light sources in two devices that have established a communication link are preferably adjusted to the substantially the same color, in order to indicate that the two devices have established a communication link. The color which is specified by two or more color coordinates, is preferably selected at random e.g., by randomly selecting one or more color coordinates, by one of the devices establishing the communication link, and communicated to other (e.g., one other) devices with which the communication link is established. Alternatively, the color of light sources in two devices is modulated in synchronism to indicate that a communication link has been established between the two devices.

One or more activatable indicia 212, 214, 216, 218 are also formed on the front housing portion 204 of the telephone 104. The activatable indicia 212-218 include two abbreviated textual indicia 216, 218 including a transmitting state indicia ‘Tx’ 216, and a receiving state indicia ‘Rx’ 218. By activating the textual indicia 216, 218 the user of the wireless telephone 104 is visually apprised as to whether the telephone 104 is transmitting or receiving information. The activatable indicia 212-218 also include graphical indicia 216, 218, including a locked lock icon 212, and an unlocked lock icon 214. The locked lock icon 212 is activated to indicate to the user that secure (i.e., encrypted) communication is taking place, and the unlocked lock icon 214 is activated to indicate to the user that unsecured (e.g., open) communication is taking place.

The activatable indicia 212-218 preferably take the form of electroluminescent, photoluminescent, or thermochromic devices. Alternatively, the activatable indicia takes the form of a pattern etched in an opaque layer of the front housing portion 204. Back lighting of the etched pattern is provided by switching on a light source located in the housing 202.

Preferably, the activatable indicia 212-218 are activated in response to the status of a short range communication link, such as a BLUETOOTH communication link. BLUETOOTH is a communication protocol developed by the BLUETOOTH SIG trade association. The name BLUETOOTH is a trademark of the BLUETOOTH SIG trade association. The activatable indicia 212-218 are useful in educating the users as to the operation of short range and ad hoc communications, and therefore may be used to promote the use of short range and ad hoc communications in a variety of applications. Locating the activatable indicia 212-218 on the front housing portion 204 tends to insure that the activatable indicia will be viewable by the user. Forming the activatable indicia on the front housing portion allows the activatable indicia 212-218 to be made relatively large and at the same time allows the activatable indicia to be incorporated in the wireless telephone 104 in a space efficient manner.

As shown in FIG. 3, the housing 202 of the wireless telephone 104 encloses a circuit substrate 314. The circuit substrate 314 supports a keypad 312 that includes the alphanumeric keys 206 and the function keys 208. The circuit substrate 314 also supports a number of other electrical circuit components 302, 304, 306, 308, 310 including a microphone 306, a speaker 308, a light source driver 304, and an activatable indicia driver 310. Although only one activatable indicia driver 310 is visible in the side view of FIG. 3, there are preferably multiple activatable indicia drivers 306 for driving all the activatable indicia 212-218.

According to an alternative embodiment of the invention, one or more of the momentary contact keys 206, 208 optionally include light sources. For example, the keys 206, 208 optionally include one or more electroluminescent lamps that are integrated with the keys 206, 208. Light sources incorporated into the keys 206, 208 are alternatively activated in order to indicate to a user that the wireless telephone 104 has established an ad hoc communication link with another device. The light sources included in the keys 206, 208 are alternatively activated in a manner (e.g., synchronously according to a timing sequence) to indicate to the user with which other device the wireless telephone 104 has established an ad hoc communication link.

According to another alternative embodiment of the invention, the display 128 is used to display a graphic (e.g., a picture randomly selected from a plurality of pictures) that is simultaneously displayed on a display of a second device (e.g. PDA 108, or laptop 106, FIG. 1) with which the wireless telephone 104 has established an ad hoc wireless communication link. Simultaneously displaying the same picture on the display 128 of the telephone 104 and on the display of the second device with which the wireless telephone 104 has established an ad hoc communication link indicates to the user (e.g., one or more users of the wireless telephone 104 and the second device) that the two devices have established a communication link.

According to yet another alternative embodiment of the invention the fact that the wireless telephone 104 is in communication with another device is indicated by driving at least a portion of the display 128 and the display of the second device according to the same timing sequence. In other words, the displays of the two devices are driven substantially synchronously. As an example, a block portion of the displays of the two devices, are synchronously, alternately driven to one of two colors according to a timing sequence.

According to yet another alternative embodiment of the invention an activatable indicia in the form of a logo 222 is operated (e.g. flashed according to a timing sequence, or adjusted to a certain color) in order to indicate that a wireless communication link has been established. The logo is preferably electroluminescent, but is alternatively photoluminescent, thermochromic, or takes the form of an etched pass through in the front housing portion 204. A etched pass through logo that is back lit by a full color LED serves as a color adjustable logo.

FIG. 4 is a block diagram of the wireless telephone 104 shown in FIG. 2 in accordance with a preferred embodiment of the invention. As shown in FIG. 4, the wireless telephone 104 comprises a transceiver module 402, a processor 404 (e.g., a digital signal processor), an analog to digital converter (AID) 406, a key input decoder 408, a plurality of indicia driver circuits 410, a digital to analog converter (D/A) 412, a display driver 414, a program memory 416, and a workspace memory 418 coupled together through a digital signal bus 420.

The transceiver module 402 is coupled to the antenna 220. Carrier signals that are modulated with data, e.g., encoded audio data, pass between the antenna 220, and the transceiver 402. Alternatively, an infrared detector, and an infrared emitter are provided for infrared wireless communication. Infrared wireless signals are alternatively used in the network 100 shown in FIG. 1. IrDA is a protocol for wireless communication that can be used in the network 100.

The microphone 306 is coupled to the A/D 406. Audio, including spoken words and ambient noise, is input through the microphone 306 and converted to digital format by the AID 406.

The keypad 312 that includes the alphanumeric keys 206, and the function keys 208 is coupled to the key input decoder 408. The key input decoder 408 serves to identify depressed keys and provide information identifying each depressed key to the processor 404.

The indicia driver circuits 410, which comprises the indicia driver 310, are coupled to an activatable indicia array 422 that includes the activatable indicia 212-218 218. The indicia driver circuits 410 drive the activatable indicia 212-218 in response to control signals received from the microprocessor 404.

The D/A 412 is coupled to the speaker 308. The D/A 412 converts decoded digital audio to analog signals and drives the speaker 308. The display driver 414 is coupled to the display 128.

The program memory 416 is used to store programs that control the wireless telephone 104. The programs stored in the program memory 416 are executed by the processor 404. The workspace memory 418 is used as a workspace by the processor 404 in executing programs. Methods that are carried out by programs stored in the program memory 416 are described below with reference to FIGS. 5-8. The program memory 416 is a form of computer readable media. Other forms of computer readable media can alternatively be used to store programs that are executed by the processor 404.

The transceiver module 402, processor 404, A/D 406, key input decoder 408, indicia driver circuits 410, D/A 412, display driver 414, program memory 416, and workspace memory 418, are preferably embodied in the electrical circuit components 302, the activatable indicia driver 310, and electrical interconnections of the printed circuit substrate 314 shown in FIG. 3.

FIG. 5 is a flow chart of method of operating the wireless telephone 104 shown in FIGS. 1-4 in conjunction with a second wireless communication enabled device (e.g., laptop 106, PDA 108, set top box 110, or network portal 102) according to the preferred embodiment of the invention. In step 502, a wireless connection or communication link is established between the wireless telephone 104 and the second wireless communication enabled device. In step 504, indicia activation information in the form of a light activation timing sequence is transmitted from the wireless telephone 104 to the second wireless communication enabled device. (Alternatively, the roles of the wireless telephone 104 and the second wireless communication enabled device are reversed.) In step 506, a synchronization signal is transmitted from the wireless telephone 104 to the second wireless communication enabled device. In step 508, the light source 316 of the wireless telephone 104 is activated according to the activation timing sequence transmitted to the second wireless communication enabled device.

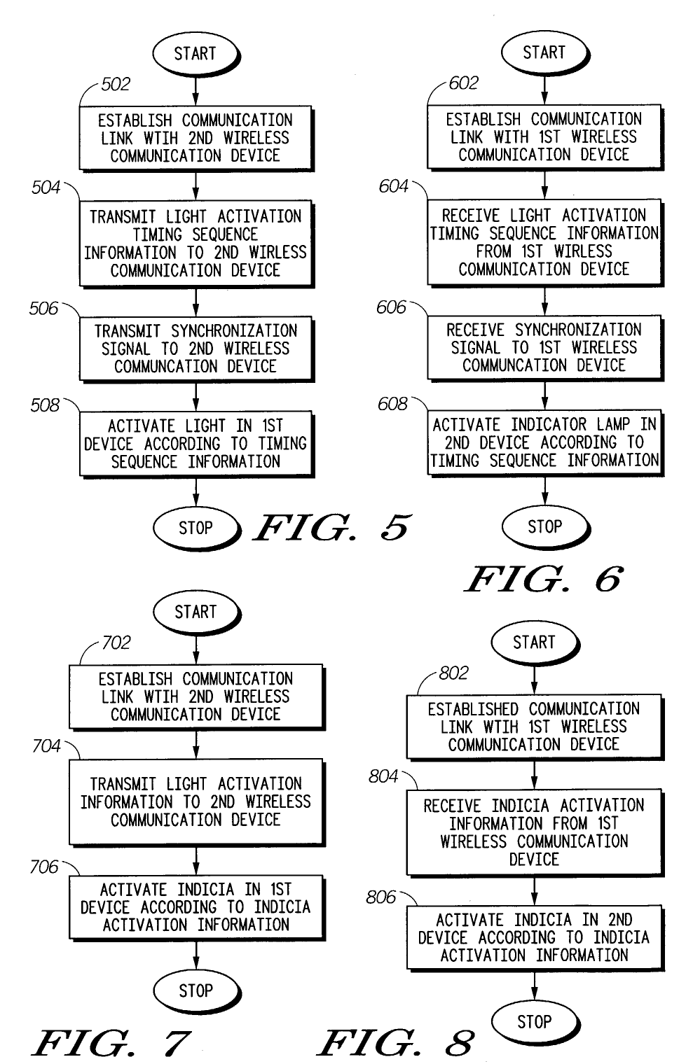

FIG. 6 is a flow chart of a method of operating a second wireless communication enabled device in coordination with the method shown in FIG. 5. In step 602, the second wireless communication enabled device functions to establish the communication link with the wireless telephone 104. (Step 602 is performed in coordination with step 502). In step 604, the light activation timing sequence information that was transmitted in step 504 is received. In step 606, the synchronization signal that was transmitted in step 506 is received. In response to receiving the synchronization signal, in step 608 an indicator lamp of the second wireless communication enabled device is driven in accordance with the light activation timing sequence information. Executing the processes shown in FIGS. 5-6 causes the light source 316 of the telephone 104 and the indicator lamp of the second wireless communication enabled device to turn on and off according to the timing sequence, in synchronism.

According to another alternative embodiment of the invention the second wireless communication device that executes the method shown in FIG. 6, establishes a communication link with a third device, and thereafter relays the light activation timing sequence to the third device, and thereafter transmits a synchronization signal to the third device, in response to which the third device activates a lamp of the third device according to the light activation timing sequence information in synchronism with the wireless telephone 104, and the second wireless communication enabled device.

FIG. 7 is flow chart of a method of operating the wireless telephone 104 shown in FIGS. 1-4 according to an alternative embodiment of the invention, and FIG. 8 is a flow chart of a method of operating a second wireless enabled communication device in coordination with the method shown in FIG. 7. Referring to FIG. 7, in step 702 a wireless communication link to a second wireless communication enabled device (e.g., laptop 106, PDA 108, set top box 110, or network portal 102) is established. In step 704 indicia activation information is transmitted to the second wireless communication enabled device. The indicia activation information that is transmitted in step 704 alternatively comprises an image that is randomly selected or randomly generated, a color to which indicator lamps are to be adjusted, a timing sequence, color modulation information, or other indicia activation information. In step 706 indicia (e.g., the display 128 or a color tunable lamp) of the wireless telephone 104 is activated according to the indicia activation information transmitted in the preceding step 704.

Referring to FIG. 8, in step 802 the second wireless communication enabled device functions to establish the communication link with the wireless telephone 104. In step 804 the indicia activation information that was transmitted in step 704 is received from the wireless telephone, and in step 806 an indicia (e.g., a display or color tunable lamp) of the second wireless enabled communication device is activated in accordance with the indicia activation information.

Using the methods illustrated in FIGS. 7,8 causes the wireless telephone 104, and the second wireless communication enabled device with which it establishes a communication link to activate their respective indicia (e.g., a display or color tunable lamp) according to the same indicia activation information (e.g., image or color) and thereby apprises users that the wireless telephone and the second wireless communication enabled device have established a communication link. Therefore the users will be reassured as to the proper functioning of the communication link.

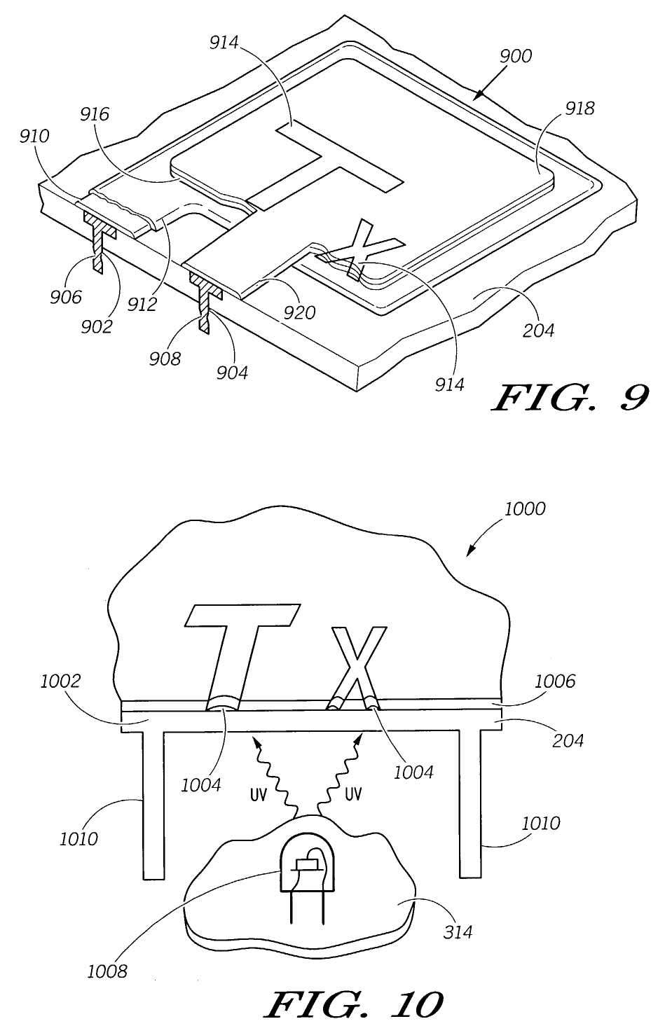

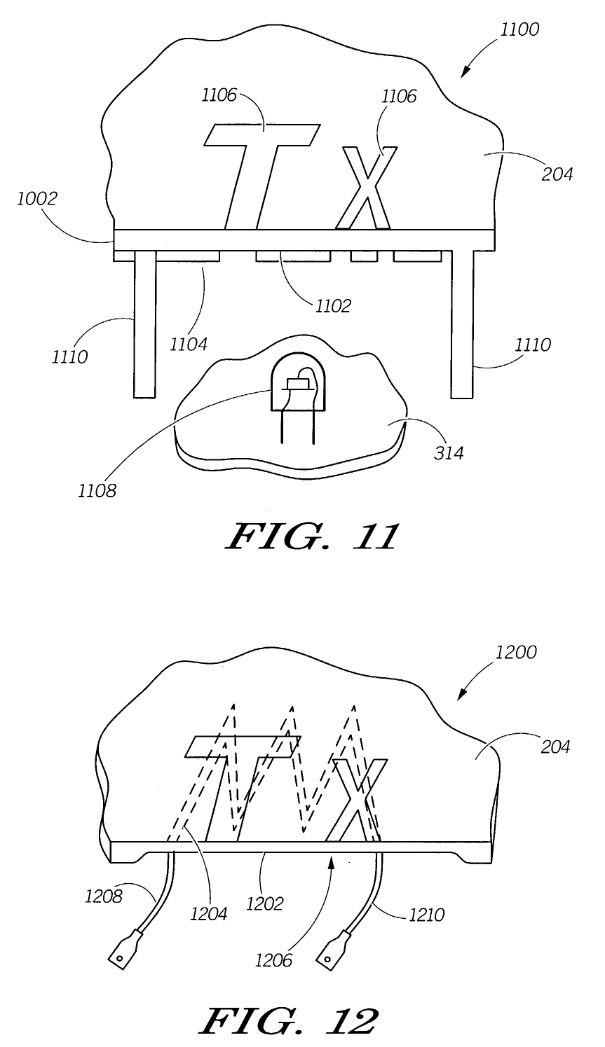

FIG. 9 is a fragmentary perspective view of the front housing portion 204 of the wireless telephone 104 shown in FIGS. 2-4 including an electroluminescent activatable indicia 900. Referring to FIG. 9, a first terminal 902, and a second terminal 904 are integrally molded in the front housing portion 204 which is preferably made of plastic. The terminals 902, 904 include respective contact portions 906, 908 located within the housing 202 of the wireless telephone 104. The contact portions 906, 908 are used to couple a voltage signal from a electroluminescent driver (not shown) to the electroluminescent activatable indicia 900.

A first conductive layer 910 extends over, and electrically contacts the first terminal 902. A first insulating layer 912 covers the first conductive layer 910. A electroluminescent layer 914 is patterned to form an abbreviated textual transmit state indicia ‘Tx’. A second insulating layer 916 that is transparent to light emitted by the electroluminescent layer 914 covers the electroluminescent layer 914. A second conductive layer 918 that is also transparent to light emitted by the electroluminescent layer 914 overlies the second insulating layer 916. The second conductive layer 918 includes a tab portion 920 that extends beyond the periphery of lower layers and contacts the second terminal 904. Thus, the terminals 902, 904 are used to apply voltage signals between the first conductive layer 910, and the second conductive layer 918. A third insulating layer (not shown) that is also transparent, is optionally formed over the second conductive layer 918. By applying a voltage signal between the conductive layers 910, 918, the electroluminescent layer 914 is caused to emit light thereby activating the transmit state indicia ‘Tx’.

FIG. 10 is a fragmentary perspective view of the front housing portion 204, and the circuit substrate 314 of the wireless telephone 104 shown in FIGS. 2-4 including a photoluminescent activatable indicia 1000. The photoluminescent activatable indicia 1000 is formed on an ultraviolet (UV) transparent portion 1002 of the housing.204. The UV transparent portion 1002 is preferably made from a UV transparent plastic. The UV transparent portion 1002 is optionally an insert that is mechanically coupled to a remainder of the housing 202. A patterned photoluminescent layer 1004 is formed on the UV transparent portion 1002. The patterned photoluminescent layer 1004 is patterned to form an abbreviated textual transmit indicia ‘Tx’. A UV blocking, visible light transmitting layer 1006 is formed on the UV transparent housing portion 1002 over the photoluminescent layer 1004. The circuit substrate 314 supports a UV LED 1008 below the abbreviated textual transmit indicia ‘Tx’. A UV light baffle skirt 1010 depends from the front housing portion 204, and encircles the transmit indicia ‘Tx’ and the UV LED 1008. The skirt 1010 serves to isolate the UV LED 1008 from other photoluminescent activatable indicia of the same general design (but with different textual or graphic information) that are preferably formed adjacent to the photoluminescent indicia 1000 shown in detail in FIG. 10.

FIG. 11 is a fragmentary perspective view of the front housing portion 204, and the circuit substrate 314 of the wireless telephone 104 shown in FIGS. 2-4 including an etched pass through type activatable indicia 1100. In the embodiment shown in FIG. 11, the front housing portion 204 comprises a body of transparent material (preferably plastic) that is coated on an inside surface 1102 with an opaque coating 1104. Alternatively, the opaque coating is coated an outside surface of the housing portion 204. The opaque coating 1104 is selectively etched, e.g. by laser etching, in order to inscribe an indicia pattern 1106. The indicia pattern 1106 shown in FIG. 11 is an abbreviated textual transmit indicia ‘Tx’. An LED 1108 is supported on the circuit substrate 314 proximate the indicia pattern 1106. A light baffle skirt 1110 depends from the front housing portion 204 surrounding the indicia pattern 1106, and the LED 1108. The light baffle skirt 1110 serves a function analogous to that of the UV light baffle skirt 1010 (FIG. 10) discussed above.

FIG. 12 is a fragmentary perspective x-ray view of the front housing portion 204 of the wireless telephone 104 shown in FIGS. 2-4 including a thermochromic activatable indicia 1200. The thermochromic activatable indicia, includes an indicia pattern (graphic or textual) printed on a thinned area 1202 of the front housing portion 204. An ohmic heating element 1204 is positioned on an inside surface 1206 of the thinned area 1202, or is embedded in the thinned area 1202. A first lead 1208, and a second lead 1210 are electrically connected to the ohmic heating element 1204 for supplying a driving current thereto. The ohmic heating element 1204 is driven by an indicia driver (not shown in FIG. 12). Making the thinned area 1202 thin tends to reduce the response time of the thermochromic activatable indicia, by reducing the heat capacity of the thinned area 1202, increasing the thermal conductance across the thinned area 1202, and decreasing lateral loss of heat from the thinned area 1202.

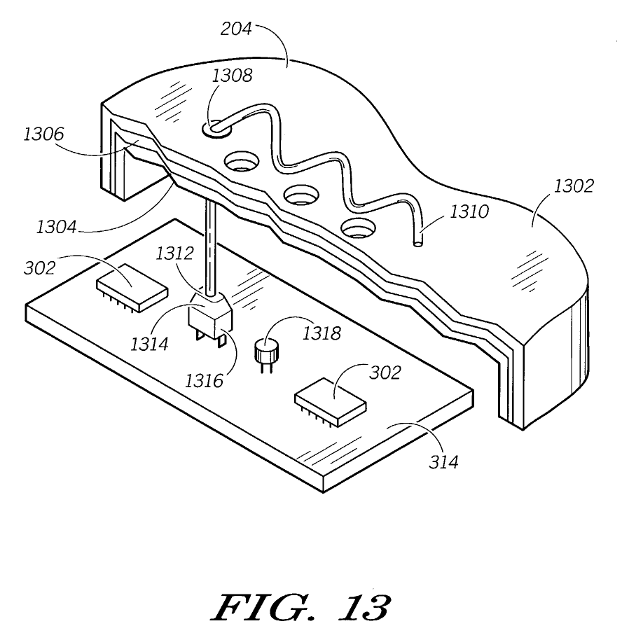

FIG. 13 is a fragmentary perspective view of the front housing portion 204, and the circuit substrate 314 of the wireless telephone 104 shown in FIGS. 2-4 including a leaky fiber indicator lamp. In the embodiment shown in FIG. 13, the front housing portion 204, comprises an outer transparent shell 1302, and an inner shell 1304 nested within the outer transparent shell 1302. A space 1306 is located between the outer transparent shell 1302, and the inner shell 1304. The inner shell 1304 includes a hole 1308. An optical fiber 1310 extends from within the housing 202 through the hole 1308 into the space 1306 between the outer transparent shell 1302 and the inner shell 1304. At least a portion of the optical fiber 1310 in the space 1306 is preferably leaky, or leaks light due to its proximity (e.g., contact) with the outer transparent shell 1302. An end 1312 of the optical fiber 1310 is coupled by an optical coupler 1314 to an LED 1316. The LED 1316 is coupled through the circuit substrate 314 to an LED driver 1318 that performs the function of the light source driver 304 shown in FIGS. 3,4.

The optical fiber 1310 serves as an indicator lamp for indicating that a communication link has been established between the wireless telephone 104, and a second wireless communication enabled device. The LED 1316 is preferably driven in synchronism with an indicator lamp in a second wireless communication enabled device so that users will be apprised that the wireless telephone 104 and the second wireless communication enabled device are in communication.

The word “integral” as used in this description means disposed on the housing, embedded within the housing, etched into the housing or otherwise forming part of the housing, but does not mean mechanically fastened to the housing.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A method for a first wireless device to alert a user thereof as to establishment of a wireless connection with a second wireless device, the method comprising:
establishing a wireless connection between the first wireless device and the second wireless device;
receiving indicia activation information from the second wireless device; and
activating a visual indicia of the first wireless device according to the indicia activation information to alert the user of the establishment of the wireless connection.

2. The method according to claim 1, wherein the visual indicia of the first wireless device comprises a light source and wherein receiving the indicia activation information comprises receiving a timing sequence for activating the light source.

3. The method according to claim 1, wherein the visual indicia of the first wireless device comprises a display screen and wherein receiving the indicia activation information comprises receiving an image for display on the display screen.

4. The method according to claim 1, wherein the visual indicia of the first wireless device comprises a first controllable color light source and wherein receiving the indicia activation information comprises receiving a color selection signal effective to control a color of the first controllable color light source.

5. A method for a first wireless device to alert a user of a second wireless device as to establishment of a wireless connection between the first wireless device and the second wireless device, the method comprising:
establishing a wireless connection between the first wireless device and the second wireless device; and
transmitting indicia activation information to the second wireless device, the indicia activation information providing instruction for visually alerting the user of the second wireless device as to establishment of the wireless connection.

6. The method according to claim 5, wherein transmitting the indicia activation information comprises transmitting a timing sequence for activating a light source of the second wireless device.

7. The method according to claim 5, wherein transmitting the indicia activation information comprises transmitting an image for display on a display screen of the second wireless device.

8. The method according to claim 5, wherein transmitting the indicia activation information comprises transmitting a color selection signal effective to control a color of a controllable color light source contained in the second wireless device.

9. The method according to claim 5, further comprising:
activating a visual indicia of the first wireless device according to the indicia activation information to alert a user of the first wireless device as to establishment of the wireless connection.

10. A wireless communication device comprising:
a wireless transceiver that receives indicia activation information from at least a second wireless communication device subsequent to establishment of at least one wireless connection between the wireless communication device and the at least a second wireless communication device; and
at least one activatable indicia that, according to the indicia activation information, visually alerts a user of the status of the at least one wireless connection.

11. The wireless communication device according to claim 10, further comprising a housing, wherein: the at least one activatable indicia comprises at least one optical fiber at least partly located within the housing.

12. The wireless communication device according to claim 10, further comprising a housing and a light source contained within the housing, wherein the activatable indicia comprises a pass through etched in the housing and wherein the light source directs light through the pass through.

13. The wireless communication device according to claim 10, further comprising:
a housing, at least a part of which is transparent to ultraviolet light; and
a light source contained within the housing;
wherein the activatable indicia comprises indicia that is formed from a photoluminescent material and is positioned on the part of the housing that is transparent to ultraviolet light; and wherein the light source excites the photoluminescent material.

14. The wireless communication device according to claim 10, further comprising a housing, wherein the activatable indicia comprises a pattern of thermochromic material disposed on the housing and a heating element located proximate the thermochromic material.

15. The wireless communication device according to claim 10, further comprising a housing, wherein the activatable indicia comprises a pattern of electroluminescent material disposed on the housing and electrodes positioned proximate the pattern of electroluminescent material for applying a voltage signal to the electroluminescent material.

16. A wireless communication device comprising:
a wireless transceiver that receives indicia activation information from at least a second wireless communication device subsequent to establishment of at least one wireless connection between the wireless communication device and the at least a second wireless communication device;
at least one activatable indicia that, responsive to a control signal, visually alerts a user of the establishment of the at least one wireless connection;
a processor coupled to the wireless transceiver and the at least one activatable indicia; and
memory coupled to the processor, the memory including operating instructions that, when executed by the processor, control the processor to at least:
generate the control signal according to the indicia activation information.

17. The wireless communication device according to claim 16, wherein the operating instructions further control the processor to:
establish at least one wireless connection between the wireless communication device and at least a third wireless communication device;
generate second indicia activation information responsive to establishing the at least one wireless connection between the wireless communication device and at least a third wireless communication device;
transmit the second indicia activation information to the at least a third wireless communication device via the wireless transceiver; and
generate the control signal according to the second indicia activation information.

18. The wireless communication device according to claim 16, wherein the second indicia activation information comprises light activation timing sequence information and a synchronization signal.

19. A wireless communication device comprising:
a housing;
a wireless transceiver;
at least one activatable indicia that is at least in part integral with the housing and that, responsive to a control signal, visually alerts a user of the establishment of a wireless connection between the wireless transceiver and at least one other wireless communication device;
a processor coupled to the wireless transceiver and the at least one activatable indicia; and
memory coupled to the processor, the memory including operating instructions that, when executed by the processor, control the processor to at least generate the control signal to indicate status information pertaining to the wireless connection.

20. The wireless communication device according to claim 19, wherein the wireless transceiver receives indicia activation information from the at least one other wireless communication device subsequent to establishment of the wireless connection and wherein the memory further includes operating instructions that control the processor to generate the control signal according to the indicia activation information.

21. A wireless communication system comprising:
a first wireless communication device that includes:
a processor that generates indicia activation information subsequent to establishment of at least one wireless connection between the first wireless communication device and at least one other wireless communication device;
a first wireless transceiver, operably coupled to the processor, that transmits the indicia activation information; and
a first activatable indicia, operably coupled to the processor, that, according to the indicia activation information, visually alerts a user of the first wireless communication device as to establishment of the at least one wireless connection; and
a second wireless communication device that includes:
a second wireless transceiver that receives the indicia activation information; and
a second activatable indicia, operably coupled to the second wireless transceiver, that, according to the indicia activation information, visually alerts a user of the second wireless communication device as to establishment of the at least one wireless connection.
